(19) United States
(12) Patent Application Publication
(10) Pub. No.: US 2012/0033537 A1
(43) Pub. Date: Feb. 9, 2012

(54) COPY STATION

(75) Inventors: David Michael Hassler, Prior Lake, MN (US); Samir Mittal, Minneapolis, MN (US); Kevin Lowell Stagg, Savage, MN (US); Christoper Ashley Wells, Minneapolis, MN (US)

(73) Assignee: RIMAGE CORPORATION, Minneapolis, MN (US)

(21) Appl. No.: 13/097,204

(22) Filed: Apr. 29, 2011

Related U.S. Application Data
(60) Provisional application No. 61/371,403, filed on Aug. 6, 2010.

(51) Int. Cl. G11B 7/28; H04N 5/225; G06K 15/02; G11B 20/00

(52) U.S. Cl. 369/53.21; 369/84; 348/207.2; 358/1.18; G9B/7.2; G9B/20.002; 348/E05.024

(57) ABSTRACT

In an embodiment, a method for making copies of a master disc is described. The method includes receiving a master disc. The method also includes capturing an image of a label on a first side of the master disc. The method also includes generating a data image of data stored on the master disc. The method also includes making one or more copies of the master disc using one or more blank discs. Making the one or more copies includes recording the data image onto a data side of each of the one or more blank discs and printing the image of the label on an opposing side of each of the one or more blank discs.

### CROSS-REFERENCE TO RELATED APPLICATIONS

The present application claims the benefit of and priority to U.S. Provisional Patent Application No. 61/371,403, filed Aug. 6, 2010 and entitled COPY STATION, which application is fully incorporated herein by reference in its entirety.

### BACKGROUND

1. Field of the Invention

Some embodiments described herein generally relate to systems and methods for publishing discs including audio and/or video discs.

2. Related Technology

Unless otherwise indicated herein, the materials described herein are not prior art to the claims in the present application and are not admitted to be prior art by inclusion in this section.

Optical discs are increasingly replacing paper documents in business workflows. Often, this drives a need in companies of all sizes for functional replicates of original discs for documentation management, data distribution or the replacement of lost discs.

Creating a functional replicate of an original optical disc is often a time-consuming and hands-on process. For instance, a user may have to manually load an original disc into an optical read/write drive to read the data from the original disc. After, the user has to manually remove the original disc from the optical drive and replace it with a blank disc. The user can then select an icon or push a button to initiate the recording of the data read from the original disc onto the blank disc, followed by manually removing the newly recorded disc from the optical drive.

If the user also desires to label the newly recorded disc, additional steps may be required. For instance, if the user desires the same or a similar label as is included on the original disc, the user has to purchase an original label from a past supplier or capture a copy of the label on the original disc, print the copy to a new label, and apply the new label to the newly recorded disc. Or, the user can manually write information on the disc.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

In general, example embodiments relate to systems and methods for publishing discs including audio and/or video discs.

In one example embodiment, a method for making copies of a master disc is described. The method includes receiving a master disc. The method also includes capturing an image of a label on a first side of the master disc. The method also includes generating a data image of data stored on the master disc. The method also includes making one or more copies of the master disc using one or more blank discs. Making the one or more copies includes recording the data image onto a data side of each of the one or more blank discs and printing the image of the label on an opposing side of each of the one or more blank discs.

In another example embodiment, a computer-readable storage medium is described that has computer-executable instructions stored thereon that are executable by a computing device to perform various operations. The operations include receiving a master disc. The operations also include capturing an image of a label on a first side of the master disc. The operations also include generating a data image of data stored on the master disc. The operations also include making one or more copies of the master disc using one or more blank discs. Making the one or more copies includes recording the data image onto a data side of each of the one or more blank discs and printing the image of the label on an opposing side of each of the one or more blank discs.

In yet another example embodiment, a copy station is described that includes a readback and recording device, a printing device, and an output bin. The readback and recording device is configured to read data from a master disc and write data to a data side of a copy disc. The printing device is coupled to the readback and recording device and is configured to receive the copy disc from the readback and recording device and to print a label image to a non-data side of the copy disc. The output bin is coupled to the printing device and is configured to receive the copy disc from the printing device.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a copy station for publishing discs;

FIG. 2 shows an example flow diagram of a method for copying a disc; and

FIGS. 3A-3D include screen shots of an illustrative embodiment of a graphical user interface (GUI) that may be implemented in a user interface included in the copy station of FIG. 1.

### DETAILED DESCRIPTION OF SOME EXAMPLE EMBODIMENTS

Example embodiments of the invention relate to systems and methods for publishing discs including audio and/or video discs. As used herein, the term “publishing discs” and variations thereof are to be broadly construed to include one or more of duplicating, copying, or printing audio and/or video discs, or any combination thereof. The discs published according to the systems and methods disclosed herein can include compact discs (CD), digital video discs (DVD), Blue-ray Discs (BD), or the like or any combination thereof. Publishing discs can be used, by way of example only, in audio/video distribution, software distribution, archiving, data distribution, medical imaging, medical records, photo and image distribution, content management, evidence processing, or the like or any combination thereof.

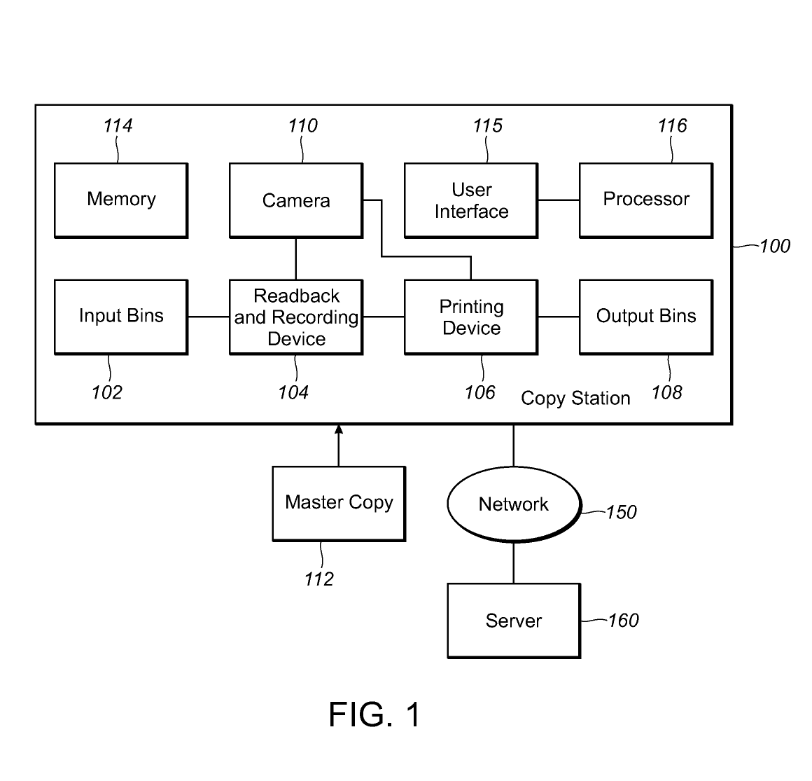

FIG. 1 illustrates an example of a copy station 100 for publishing discs. The copy station 100 includes one or more input bins 102, a readback and recording device 104, a printing device 106, one or more output bins 108, and a camera 110. The copy station 100 may also include a user interface 115, a processor 116 and memory 114.

The memory 114 may be used to store programs or modules that are used when publishing discs. The programs or modules may include computer-executable instructions. The programs or modules, when executed by the processor 116 or other computing device, may cause the processor to perform image processing operations, data processing operations, or the like. The processor 116 controls the operation of the copy station 100 and may independently control each component. Thus, the operation of the copy station 100 may be controlled by hardware, software, and/or firmware.

The user interface 115 is coupled to the processor 116. In some embodiments, the user interface 116 includes a touchscreen user interface. More generally, the user interface includes one or more input/output devices for receiving input from and/or providing output to a user. For instance, the input/output devices of the user interface 115 may include one or more of a touchscreen display, a non-touchscreen display, a keyboard, a mouse, a speaker, or the like or any combination thereof. The user interface 115 may also include a GUI including a program or programs executed by the processor 116 to interface with a user.

The copy station 100 may be an integrated unit or may be implemented as discrete components. In addition, the copy station 100 can be a network connected device. In this example, the copy station 100 may connect over a network 150 with a device such as a server 160. The network 150 may be a local area network, a wide area network, the Internet, or any combination thereof. In addition, the network 150 can include wireless and/or wired networks.

In some embodiments, the processor 116 executes an application effective to control operation of one or more of the components of the copy station 100 to perform one or more of the functions, operations, and/or acts described herein. The application may be stored in the memory 114. Alternately or additionally, the server 160 may execute the application, or a copy of the application, so as to control operation of one or more of the components of the copy station 100 remotely.

The copy station 100 can be controlled remotely from the server 160 over the network 150. The copy station 100 can also be controlled robotically. For example, robotics may be used to load discs into the input bins 102 and/or to remove completed discs from the output bins 108. More generally, the copy station 100 may include components that enable the discs to be loaded into the readback and recording device 104 automatically. A feeder may feed the discs from the input bins 102 into the readback and recording device 104.

The copy station 100 is typically configured to publish discs, which as previously described, may include copying data, taking an image of a disc's label with a camera, recording an image onto a blank disc, printing a label, or the like or any combination thereof. The copy station 100 includes input bins 102 that are configured to store blanks. The input bins 102 can store different types of blanks that can be loaded into the readback and recording device 104 automatically. For example, the input bins 102 may include a first bin for one type of blank discs (e.g., BD discs) and other bins for other types of blank discs. Alternatively, each bin may be loaded with the same type of disc. The discs can be loaded into the readback and recording device 104.

The readback and recording device 104 may include multiple readers and/or recorders, which can be swapped out with other readers and/or recorders to modify the capabilities of the copy station 100. The recorders are configured to record data (e.g., video, audio and/or other forms of data) onto the blanks in the input bins 102. The recorders included in the readback and recording device 104 may also have the ability to read data from a master copy 112, and then subsequently record the read data on the blank discs. For example, the readback and recording device 104 may be able to make an image of the data on the master copy 112 and subsequently record the data image onto the blank discs.

After the blanks are recorded by the readback and recording device 104, the printing device 105 may print an image such as a design label onto the blanks. The image can be designed using image software. The printing device 106 may provide various printing options. In one example of thermal retransfer printing, the printing device 106 conducts a process where a reverse image is printed on a retransfer sheet and the completed image is then adhered to the surface of the blank. The surface of the blank may be specially prepared for the retransfer sheet. The printing device may also be able to provide thermal printing or ink jet printing. The corresponding blank may be specifically selected for the type of printing being performed.

After the disc is completed, e.g., after the image is recorded on the blank and/or an image has been printed on the disc, the disc is placed in one of the output bins 108. Discs in the output bins 108 can then be retrieved for packaging, distribution, or the like.

FIG. 1 also illustrates that the copy station 100 can include a camera 110. The camera 110 can be used when duplicating a master copy 112. For example, the master copy 112 may be received by the copy station and placed such that the camera 110 can obtain an image of the label of the master copy 112. This image is then stored in the memory 114. At the same time, the data stored on the master copy 112 may be copied by the readback and recording device 104 and stored, for example, as a data image.

Alternatively, the camera 110 can be used independently from the readback and recording device 104. For example, the camera 110 may be used to obtain an image or images of a disc whether or not the data side of the disc is also being copied. The obtained image may be stored in memory 114 and/or transmitted over the network 150 to the server 160, a client device (not shown) with associated storage, or other remote storage location.

When publishing copies of the master copy 112, the data image is recorded onto blanks taken from the input bins 102. The label image (obtained, by way of example only, from the camera 110 or from user input) is then printed onto the blank discs by the printing device 106. Effectively, in these and other embodiments, the copy station 100 has the capability to copy both sides of the master copy 112 and produce copies that are substantially identical to the master copy 112 in terms of data and in terms of look and feel.

The camera 110 can therefore obtain an image of the label of the master copy 112. The image obtained by the camera 110 can be appropriately sized for the blanks in the input bins 102. More specifically, the camera 110 can be used to take a picture of, e.g., a label on the master copy 112, which master copy 112 may be a pre-recorded disc. The captured image can then be printed on the blanks before or after recording data onto the disc.

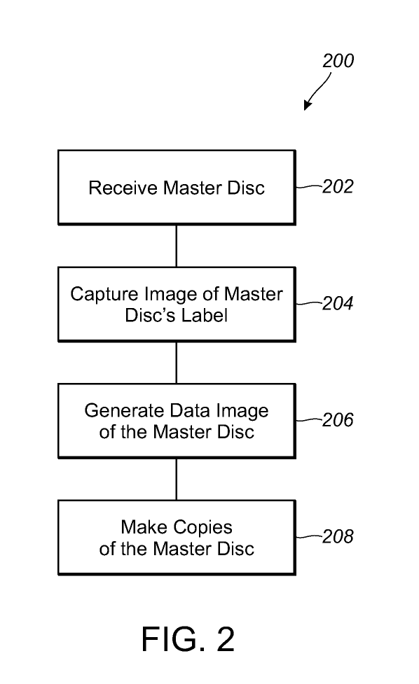

FIG. 2 shows an example flow diagram of a method 200 for copying a disc. With combined reference to FIGS. 1 and 2, the method 200 often begins, in block 202, by receiving a master disc or a set of master discs via the input bins 102. Alternatively, the master disc or set of master discs can be provided or received in another manner. The master disc is typically received either by manually placing the master disc(s) into a tray associated with the readback and recording device 104 or by placing the master disc(s) into one of the input bins 102 of the copy station.

One of skill in the art can appreciate that the master disc may include a set of master discs. In this case, the camera 110 can take an image of the label of each disc in the set. Thus, the label image for a set of master discs may include the image of each of the discs in the set of master discs. Analogously, the data image as a whole for a set of master discs may include a separate data image for each disc in the set of master discs. In this sense, reference to a master disc includes instances where the master disc is a set of discs. Thus, taking an image of the label of a first side of a master disc may include, for example, taking an image of each label of each disc in a set of master discs.

The master disc has two sides. Data is stored on one side and a label of some type is typically located on the other side. In block 204, an image of the master disc's label is captured with a camera, such as the camera 110 or a separate camera, and stored by the copy station 100. The image of the label can be manipulated if desired at the copy station 100. For example, image editing software can be used to alter the image either remotely or at the copy station 100.

In block 206, a data image of the master disc is generated, for example by reading the master disc(s) using the readback and recording device 104 of copy station 100. The data image can be stored, for example, in memory 114 of the copy station 100. Multiple master discs can be processed concurrently according to some embodiments.

In block 208, copies of the master disc are made using one or both of the label image or the data image. Accordingly, making 208 copies of the master disc may include one or both of recording data onto the data side of one or more blank discs (multiple discs can be created at the same time) or printing the label image onto the other side of the blank discs. The resulting copies may be substantially the same as the master copy.

The data image may be recorded onto the data side of one or more blank discs by the readback and recording device 104, for instance. The label image may be printed onto the other side of the one or more blank discs by the printing device 106, for instance. The data image may be recorded first followed by printing the recorded image, or vice versa.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In an illustrative embodiment, any of the operations, processes, etc. described herein can be implemented as computer-executable instructions stored on a computer-readable medium. The computer-executable instructions can be executed by a processor of a mobile unit, a network element, and/or any other computing device.

Returning to FIG. 1, the copy station 100 is generally configured to make an exact copy of the contents, e.g., data, of a master disc. In some embodiments, the copy station 100 is configured to not duplicate copy protected discs. If a copy protected disc is input for copying, the copy station 100 in some examples provides an error message stating that the disc cannot be copied because it is copy protected.

The copy station 100 is configured to make a copy of the disc label information from the original master disc onto the copied disc. As previously described, the copy of the disc label can be achieved with the camera 110 that captures an image of the disc label and the printing device 106 that prints the captured image onto the blanks used to make the copies of the original master copy.

The copy station 100, by way of example only, is able to reproduce font size of 5 point and larger although smaller font sizes can also be reproduced in some embodiments.

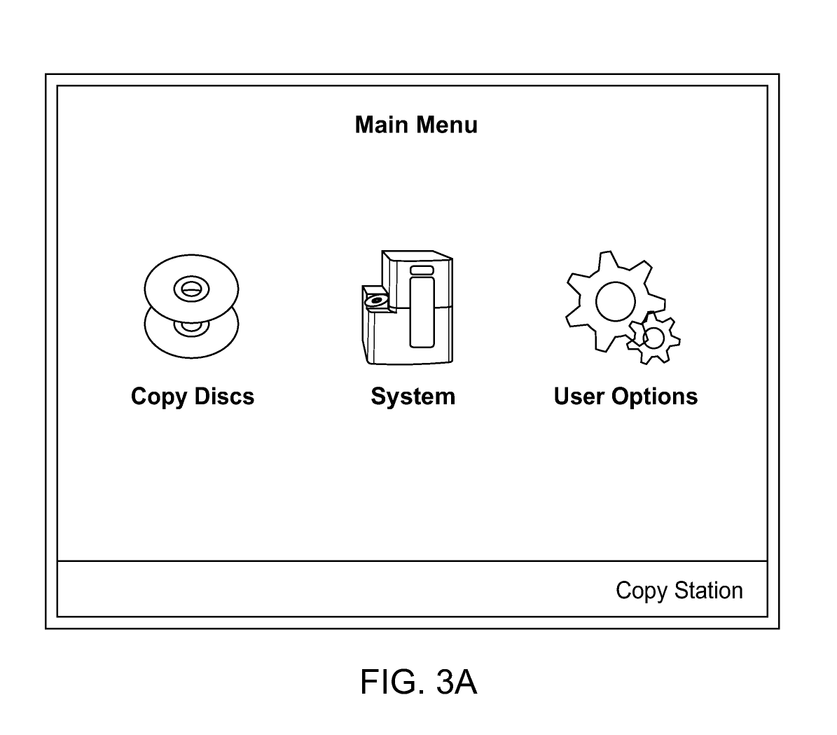

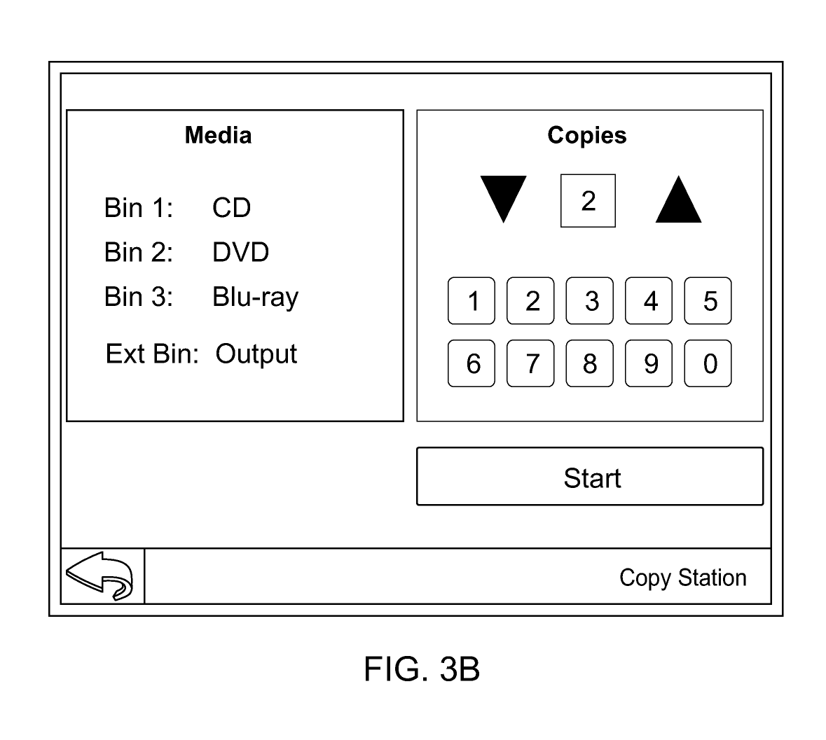

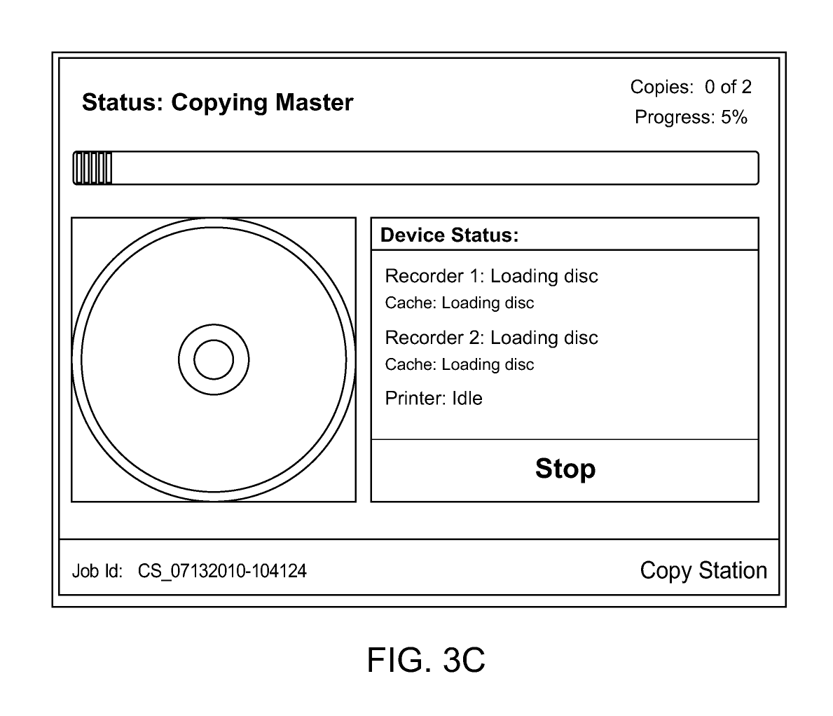

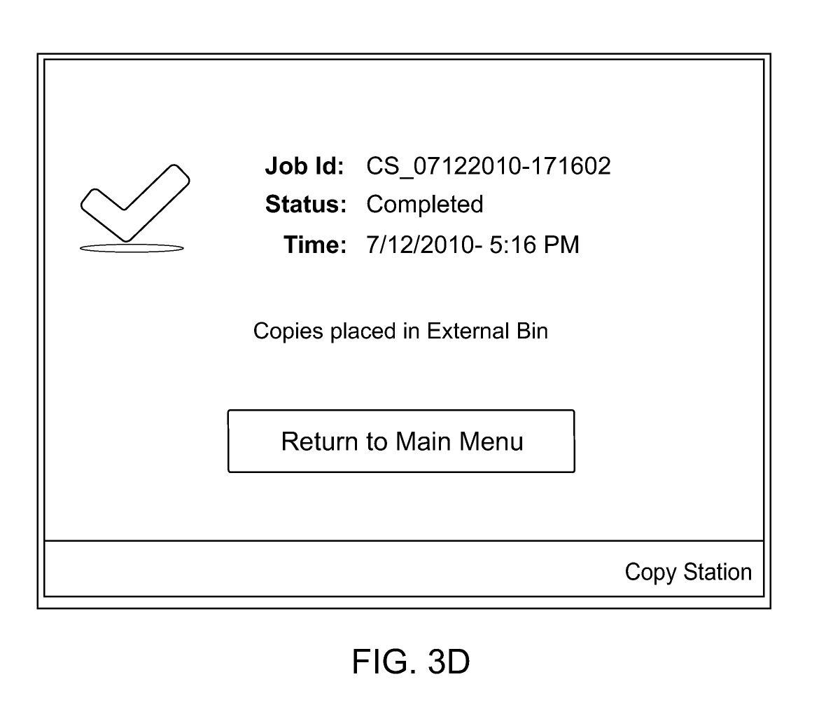

FIGS. 3A-3D include screens shots of an illustrative embodiment of a GUI that may be implemented in the user interface 115 of FIG. 1, arranged in accordance with at least some embodiments described herein. FIGS. 3A-3D may be discussed below with additional reference to FIG. 1. The GUI of FIGS. 3A-3D may be displayed on a touchscreen or other display included in the user interface 115 of FIG. 1. Moreover, user input such as the selection of an icon, or the like, may be provided via an appropriate input device, such as a touchscreen, keyboard, mouse, or other suitable input device included in the user interface 115 of FIG. 1.

FIG. 3A illustrates a main menu screen that may be presented in the user interface 115 according to some embodiments. Selection of the “Copy Discs” icon may initiate a workflow to create one or more copies of a master disc. Selection of the “System” icon may permit a user to view or edit various system parameters, such as parameters of the copy station 100 hardware including the input bins 102, readback and recording device 104, camera 110, printing device 106, and output bins 108. Selection of the “User Options” icon may permit a user to configure various settings, or the like.

FIG. 3B illustrates a copy screen of the user interface 115 that may be presented to the user in response to selection of the “Copy Discs” icon from the main menu screen of FIG. 3A. In one example, when the copy station 100 copies a master disc, it “auto-detects” a media type of the master disc and selects the same media type for copying. Alternately or additionally, a user may manually select the desired media type by selecting a corresponding one of the input bins 102 via the “System” icon from the main menu screen of FIG. 3A. In these and other embodiments, the media types available in the input bins 102 of the copy station 100 may be displayed in a “Media” portion of the copy screen of FIG. 3B.

In some embodiments, the user interface 115 of the copy station 100 can allow a user to make multiple copies. In these and other embodiments, a user may input the number of copies to be made via the user interface 115, and more particularly, via the copy screen of FIG. 3B, for instance.

The user interface 115 may include a keypad or touchpad to receive input for the number of copies, as illustrated in FIG. 3B. The number of copies can also be received over the network 150 from a remote device or server 160. Copying may begin in response to selection of the “Start” icon of FIG. 3B.

The user interface 115 may include a progress bar showing the progress of a copy job, an indicator showing if the copy station 100 is busy doing another copy job, or doing another application's job (e.g., EDS or Surveillance). If doing another job, the copy station 100 may not be available to do a copy job. However, the copy station 100 may be able to multiplex the copy jobs. FIG. 3C illustrates an example status screen of the user interface 115 including a progress bar showing the progress of a copy job. FIG. 3D illustrates an example job completion screen of the user interface 115 that may be displayed when a copy job is completed.

With renewed reference to FIG. 1, the user interface 115 may be a touchscreen that can be mounted at an adjustable angle and be viewable from multiple angles. In some embodiments, the user interface 115 of the copy station 100 does not allow general access to the operating system. A provider may be able to access the operating system, for example, to provide service, perform updates, etc.

The user interface 115 of the copy station 100 may have an optional mode where the label can be obtained from the disc content rather than from the camera. The user interface 115 (e.g., the touchscreen) may allow an end user to access log files and a system manager in order to troubleshoot over the phone, support the ability to allow diagnostics and troubleshooting to be performed remotely.

The copy station 100 may provide an estimate of time remaining on an outside job (e.g., Surveillance) so a user knows when to come back to start their copy job.

The output disc label may not have shadows or reflections in one example. In addition, coloring of the output disc label can be specified. In this regard, “coloring” of the output disc label may refer to a color of the output disc label, or a color (or colors) of ink used to print the output disc label. Also, the image of the label is of sufficient quality in some embodiments such that copies of copies of copies can be legible.

The copy station 100 may have a label watermarking option. This may be enabled/disabled from an administrator setup area accessed through the user interface 115. The administrator setup area may also be where the user inputs the watermark text according to some embodiments. In addition, the watermark may be included in the image of the label taken by the camera. This may enable the copies to be identified.

The copy station 100 may be able to pause disc publishing jobs and then enable copies to be made.

Embodiments of the copy station 100 disclosed herein include a camera 110 installed, for example in a box on top of the copy station 100. The camera 110 can take pictures of the disc, which may include taking pictures of a label attached to or printed on the disc in some embodiments. The copy station 100 also includes a touch screen panel mounted on top in one example. The copy station 100 also includes a user interface 115 that may be visual, tactile, and/or audible. The copy station 100 can be used to make copies of discs as disclosed herein.

Embodiments disclosed herein may include hardware and/or software implementations. The implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented processors, or other integrated formats. However, those skilled in the art will recognize that some aspects of the embodiments disclosed herein, in whole or in part, can be equivalently implemented as one or more computer programs running on one or more computers (e.g., as one or more programs running on one or more computer systems), as one or more programs running on one or more processors (e.g., as one or more programs running on one or more microprocessors), as firmware, or as virtually any combination thereof.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer and include both transitory and non-transitory computer-readable media. By way of example, and not limitation, such non-transitory computer-readable media can comprise RAM, ROM, EEPROM, CD-ROM or other optical disk storage, magnetic disk storage or other magnetic storage devices, or any other non-transitory medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for making copies of a master disc, the method comprising:
receiving a master disc;
capturing an image of a label on a first side of the master disc;
generating a data image of data stored on the master disc; and
making one or more copies of the master disc using one or more blank discs, including recording the data image onto a data side of each of the one or more blank discs and printing the image of the label on an opposing side of each of the one or more blank discs.

2. The method of claim 1, wherein the master disc includes a plurality of discs.

3. The method of claim 2, wherein capturing an image of a label on a first side of the master disc includes capturing a plurality of images including an image of a label on each of the plurality of discs making up the master disc.

4. The method of claim 2, wherein generating a data image of data stored on the master disc includes generating a plurality of data images including a data image of data stored on each of the plurality of discs making up the master disc.

5. The method of claim 2, wherein making one or more copies of the master disc includes making a plurality of copies including one or more copies of each of the plurality of discs making up the master disc.

6. The method of claim 1, wherein generating a data image of data stored on the master disc includes reading the data from a data side of the master disc.

7. The method of claim 1, wherein printing the image of the label includes printing, superimposed on the image of the label, a watermark input by a user.

8. The method of claim 1, further comprising receiving, from a user interface, a network-attached server, or a network-attached remote device, input specifying a number of copies to make of the master disc.

9. The method of claim 1, wherein the master disc comprises a first master disc, the method further comprising:
receiving a second master disc that is copy-protected; and
providing an error message indicating that the second master disc is copy protected and cannot be copied.

10. The method of claim 1, wherein the master disc comprises a first master disc, the method further comprising:
receiving a second master disc, the second master disc including data stored on a data side of the second master disc, the data including a representation of a label image of the second master disc; and
making a copy of the second master disc using a blank disc, including recording a data image from the second master disc onto a data side of the blank disk and printing the label image extracted from data stored on the data side of the second master disc on an opposing side of the blank disc.

11. A computer-readable storage medium having computer-executable instructions stored thereon that are executable by a computing device to perform operations comprising:
receiving a master disc;
capturing an image of a label on a first side of the master disc;
generating a data image of data stored on the master disc; and
making one or more copies of the master disc using one or more blank discs, including recording the data image onto a data side of each of the one or more blank discs and printing the image of the label on an opposing side of each of the one or more blank discs.

12. The computer-readable storage medium of claim 11, wherein receiving the master disc includes receiving the master disc in a readback and recording device from an input bin.

13. The computer-readable storage medium of claim 11, wherein the master disc includes a plurality of discs.

14. The computer-readable storage medium of claim 11, wherein generating a data image of data stored on the master disc includes reading the data from a data side of the master disc.

15. A copy station, comprising:
a readback and recording device configured to read data from a master disc and write data to a data side of a copy disc;
a printing device coupled to the readback and recording device, the printing device configured to receive the copy disc from the readback and recording device and to print a label image to a non-data side of the copy disc;
an output bin coupled to the printing device and configured to receive the copy disk from the printing device.

16. The copy station of claim 15, further comprising a camera in communication with the printing device, the camera configured to capture the label image from a label on the master disc and to communicate the label image to the printing device.

17. The copy station of claim 15, further comprising a processor and a computer-readable storage medium having computer-executable instructions stored thereon that are executable by the processor to control operation of the copy station.

18. The copy station of claim 17, further comprising a touchscreen user interface in communication with the processor.

19. The copy station of claim 15, further comprising a plurality of input bins coupled to the readback and recording device and configured to feed copy discs to the readback and recording device.

20. The copy station of claim 19, wherein the copy discs include one or more of compact discs (CD), digital video discs (DVD) or Blue-ray Discs (BD).
